(19) United States
(12) Patent Application Publication
(10) Pub. No.: US 2020/0050280 A1
(43) Pub. Date: Feb. 13, 2020

(54) OPERATION INSTRUCTION EXECUTION METHOD AND APPARATUS, USER TERMINAL AND STORAGE MEDIUM

(71) Applicant: BEIJING 7INVENSUN TECHNOLOGY CO., LTD., Beijing (CN)

(72) Inventors: Xianghui Kong, Beijing (CN); Linchan Qin, Beijing (CN); Tongbing Huang, Beijing (CN)

(21) Appl. No.: 16/535,280

(22) Filed: Aug. 8, 2019

(30) Foreign Application Priority Data
Aug. 10, 2018 (CN) 201810912697.8

(51) Int. Cl. G06F 3/01; G06F 3/0488

(52) U.S. Cl. CPC G06F 3/017; G06F 2203/04803; G06F 3/04886; G06F 3/013

(57) ABSTRACT

Provided are an operation instruction execution method and apparatus, user terminal and storage medium. The method includes following steps: a gaze point of a user staring at a display interface and information of eye movement are acquired; if the gaze point is in a preset eye control area, the information of the eye movement is analyzed to obtain a type of the eye movement; an operation instruction is executed according to the type of the eye movement and the gaze point.

### CROSS-REFERENCE TO RELATED APPLICATIONS

This application claims priority to Chinese patent application No. 201810912697.8 filed with the Patent Office of the People's Republic of China on Aug. 10, 2018, the disclosure of which is incorporated herein by reference in its entirety.

### TECHNICAL FIELD

The embodiments of the present disclosure relate to eye control technology and, in particular, to an operation instruction execution method and apparatus, user terminal and storage medium.

### BACKGROUND

With the development of science and technology, smartphones have become a part of life of people.

In order to provide a user with a display screen of the smartphone for better viewing, the size of the display screen has gradually increased from 4 inches to 6 inches or more. However, at present, a touch screen is a standard component of the smartphone. Thus, an oversized display screen will bring inconvenience to a touch action of the user. Especially, when the user grips the smartphone with one hand (for example, in a subway or at a meal), a thumb of the hand griping the smartphone cannot reach the entire touch screen. This causes inconvenient operations and misoperations, and may also cause the smartphone to slip from the hand and to be damaged.

### SUMMARY

The present disclosure provides an operation instruction execution method and apparatus, user terminal and storage medium, to implement control on an entire display screen of a user terminal.

In the first aspect, an embodiment of the present disclosure provides an operation instruction execution method. The method includes steps described below.

A gaze point of a user staring at a display interface and information of eye movement are acquired.

If the gaze point is in a preset eye control area, the information of the eye movement is analyzed to obtain a type of the eye movement.

An operation instruction is executed according to the type of the eye movement and the gaze point.

Optionally, the display interface includes the preset eye control area and a preset touch control area. The preset eye control area has an eye control function or a touch control function, and the preset touch control area has the touch control function.

Optionally, the method further includes steps described below.

A hand gesture of the user is detected.

If the hand gesture is a gesture of griping a user terminal with two hands or a gesture of holding the user terminal with two hands, the preset touch control area is configured to an entire area of the display interface.

If the hand gesture is a gesture of griping and touching the user terminal with a right hand, the preset touch control area is configured to a right touch control area and the preset eye control area is configured to an area of the display interface other than the right touch control area. The right touch control area is a maximal touchable area for a thumb of the right hand when the user grips the user terminal with the right hand.

If the hand gesture is a gesture of griping and touching the user terminal with a left hand, the preset touch control area is configured to a left touch control area and the preset eye control area is configured to an area of the display interface other than the left touch control area. The left touch control area is a maximal touchable area for a thumb of the left hand when the user grips the user terminal with the left hand.

Optionally, the step in which the operation instruction is executed according to the type of the eye movement and the gaze point includes steps described below.

The operation instruction is generated in response to the type of the eye movement and the gaze point.

It is determined whether a touch instruction triggered by a touch action and not executed exists.

If the touch instruction exists, execution of the operation instruction is prohibited and the touch instruction is executed.

If the touch instruction does not exist, the operation instruction is executed.

Optionally, after the step in which it is determined whether the touch instruction triggered by the touch action and not executed exists, the method further includes steps described below.

If the touch instruction exists, a position range of the touch action acting on the display interface is acquired.

If the position range of the touch action acting on the display interface coincides with a position range of the gaze point, the touch instruction is executed and the execution of the operation instruction is prohibited.

If the position range of the touch action acting on the display interface does not coincide with a position range of a target icon, the operation instruction is executed and execution of the touch instruction is prohibited.

Optionally, the step in which the operation instruction is generated in response to the type of the eye movement and the gaze point includes steps described below.

It is determined whether the type of the eye movement is a preset type.

If the type of the eye movement is the preset type, the operation instruction is acquired according to a position of the gaze point and a preset correspondence table of a plurality of instructions.

Optionally, the step in which the gaze point of the user staring at the display interface and the information of the eye movement are acquired includes steps described below.

Eye feature of the user and the information of the eye movement are acquired.

Position information of the gaze point is determined according to the eye feature.

In the second aspect, an embodiment of the present disclosure further provides an operation instruction execution apparatus. The apparatus includes an acquisition module, an analysis module and an execution module.

The acquisition module is configured to acquire the gaze point of the user staring at the display interface and the information of the eye movement.

The analysis module is configured to, if the gaze point is in the preset eye control area, analyze the information of the eye movement to obtain the type of the eye movement.

The execution module is configured to execute the operation instruction according to the type of the eye movement and the gaze point.

In the third aspect, an embodiment of the present disclosure further provides a user terminal.

The user terminal includes at least one processor and a storage device.

The storage device is configured to store at least one program.

The at least one program, when executed by the at least one processor, causes the at least one processor to implement any one of the operation instruction execution methods in the first aspect.

In the fourth aspect, an embodiment of the present disclosure further provides a computer readable storage medium. Computer programs are stored in the computer readable storage medium. The computer programs, when executed by a processor, implement any one of the operation instruction execution methods in the first aspect.

The embodiments of the present disclosure provide eye control for the user terminal in the preset eye control area and provides touch control for the user terminal in an area other than the preset eye control area, so that the user may operate at any position of the display interface. In this way, an effect of controlling on an entire screen is achieved, convenient control of a display screen is achieved, misoperations are reduced and user experience is improved.

### DESCRIPTION OF DRAWINGS

The drawings described here are adopted to provide a further understanding to the disclosure and form a part of the disclosure. Schematic embodiments of the disclosure and descriptions thereof are adopted to explain the disclosure and not intended to form improper limits to the disclosure. Among the drawings:

FIG. 1 is a flowchart of an operation instruction execution method in an embodiment 1 of the present disclosure;

FIG. 2 is a flowchart of an operation instruction execution method in the embodiment 1 of the present disclosure;

FIG. 3 is a flowchart of an operation instruction execution method in the embodiment 1 of the present disclosure;

FIG. 4 is a flowchart of an operation instruction execution method in the embodiment 1 of the present disclosure;

FIG. 5 is a flowchart of an operation instruction execution method in the embodiment 1 of the present disclosure;

FIG. 6 is a flowchart of an operation instruction execution method in an embodiment 2 of the present disclosure;

FIG. 7 is a structural diagram of an operation instruction execution apparatus in an embodiment 3 of the present disclosure;

FIG. 8 is a structural diagram of an operation instruction execution apparatus in the embodiment 3 of the present disclosure;

FIG. 9 is a structural diagram of an operation instruction execution apparatus in the embodiment 3 of the present disclosure;

FIG. 10 is a structural diagram of an operation instruction execution apparatus in the embodiment 3 of the present disclosure;

FIG. 11 is a structural diagram of an operation instruction execution apparatus in the embodiment 3 of the present disclosure; and

FIG. 12 is a structural diagram of a user terminal in an embodiment 4 of the present disclosure.

### DETAILED DESCRIPTION

The present disclosure will be further described in detail hereinafter in conjunction with the drawings and embodiments. It may be understood that the specific embodiments described herein are used only for interpreting the present disclosure and not for limiting the present disclosure. In addition, it should be noted that, for ease of description, the drawings only shows a part related to the present disclosure, not the whole structure of the present disclosure.

### Embodiment 1

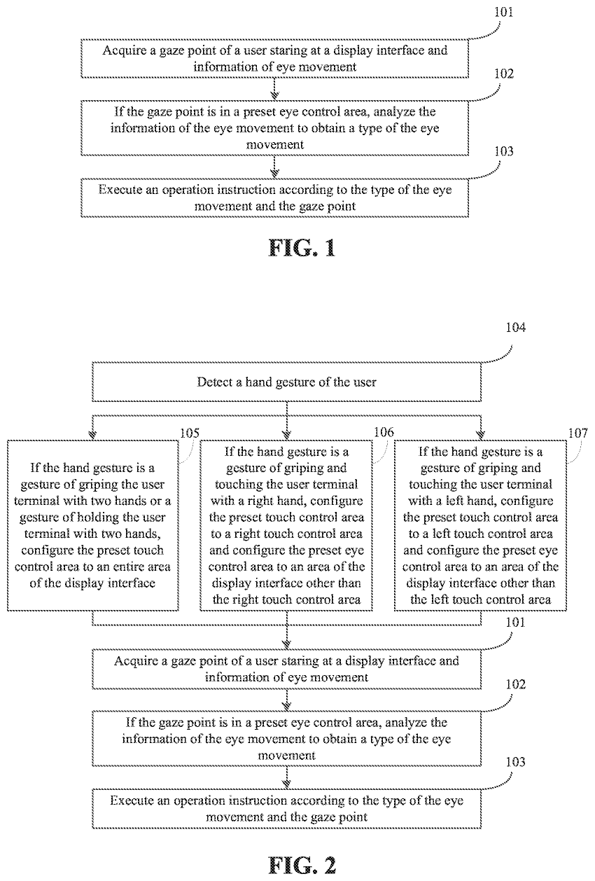

FIG. 1 is a flowchart of an operation instruction execution method in the embodiment 1 of the present disclosure. The embodiment 1 may be applied to control of a user terminal. The method may be performed by an operation instruction execution apparatus, and the apparatus is applied to the user terminal. The method includes steps described below.

In S101, a gaze point of a user staring at a display interface and information of eye movement are acquired.

The information of the eye movement is obtained by scanning with a front-facing camera in the user terminal. The information of the eye movement may include information of blink, information of long-time stare, information of squint, information of glare, etc.

Specifically, extraction of the information of the eye movement includes following steps: a camera scans a face to obtain multiple scanned images, and an eye area of eyes is identified from each of the scanned images; if there is a case where the number of pixels in the eye area having the gray-scale value changed more than a preset value between two successive scanned images is greater than a preset value and this case consecutively occurs for multiple times, it is determined that the eyes of the user moved. In this way, image information of the eye area in these consecutive times is used as the information of the eye movement.

The gaze point is a point on the display interface at which the eyes of the user stare. For example, it is supposed that the display interface is a desktop interface, in which multiple icons are displayed. When the user stares at one of the multiple icons, the position of the icon is thus the position of the gaze point. At the same time, when the user stares at the gaze point, the information of the eye movement also needs to be obtained through the front-facing camera.

The gaze point may be obtained through sensing line-of-sight of the user. The line-of-sight of the user is determined through an iris position of the user, pupils of the eyes and other eye features.

The display interface is an interface displayed on the display screen of the user terminal, such as the desktop interface and an application interface.

In S102, if the gaze point is in a preset eye control area, the information of the eye movement is analyzed to obtain a type of the eye movement.

If the gaze point is in an area other than the preset eye control area, analysis of the information of the eye movement is prohibited and the user terminal may be controlled through touch control on the area other than the preset eye control area.

The preset eye control area is an area that may control the user terminal through eye control.

The eye control refers to execution of a corresponding operation instruction for the displayed content through various movements of the eyes. The preset eye control area is configured on the display interface. The preset eye control area may be pre-configured by the user terminal or be configured by the user. For example, an upper half area of the display interface may be configured to be the preset eye control area. Preferably, when the user grips the user terminal with one hand, the preset eye control area is an area of the display screen where a thumb of the hand cannot touch.

Specifically, the step in which the analysis of the information of the eye movement is prohibited may include following steps: the information of the eye movement is compared with movement information of a preset type; when the information of the eye movement matches with the movement information of the preset type, the eye movement is determined to be of the preset type. The type of the eye movement includes blink, stare, glare, squint, etc.

In S103, an operation instruction is executed according to the type of the eye movement and the gaze point.

For example, it is supposed that an application icon is displayed at the position of the gaze point, and the type of the eye movement is stare; if the application icon has been stared at for longer than preset time, an operation instruction used for opening an application corresponding to the application icon is executed.

On the basis of the above technical solution, the display interface includes the preset eye control area and a preset touch control area. The preset eye control area has an eye control function or a touch control function, and the preset touch control area has the touch control function.

For example, the display interface may be divided into an upper half part and a lower half part.

The upper half part is the preset eye control area and the lower half part is the preset touch control area. In this way, the upper half part of the user terminal, which is far away from fingers of the user, may be controlled through the eye control, while the lower part of the user terminal, which is close to the fingers of the user, may be controlled through touch. This significantly facilitates the use by the user and avoids a problem that the user cannot control the entire screen.

The embodiment provides eye control for the user terminal in the preset eye control area and provides touch control for the user terminal in an area other than the preset eye control area, so that the user may operate at any position of the display interface. In this way, an effect of controlling on an entire screen is achieved, convenient control of a display screen is achieved, misoperations are reduced and user experience is improved.

On the basis of the above technical solution, as shown in FIG. 2, the method further includes steps described below.

In S104, a hand gesture of the user is detected.

Optionally, multiple pressure sensors may be arranged on side faces of the user terminal. When the user terminal is griped, the number of the pressure sensors having sensed pressure on the left side face of the user terminal and the number of the pressure sensors having sensed pressure on the right side face of the user terminal are acquired respectively. If the number of the pressure sensors having sensed pressure on the left side face minus the number of pressure sensors having sensed pressure on the right side face is greater than a first preset value, the user terminal determines that the user terminal is gripped with a left hand. That is, the hand gesture is a gesture of griping and touching the user terminal with the left hand. If the number of the pressure sensors having sensed pressure on the left side face minus the number of pressure sensors having sensed pressure on the right side face is less than a second preset value, the user terminal determines that the user terminal is gripped with a right hand. That is, the hand gesture is a gesture of griping and touching the user terminal with the right hand. If the number of pressure sensors having sensed pressure on the left side face minus the number of pressure sensors having sensed pressure on the right side face is in a preset range, the user terminal determines that the user terminal is held with two hands. That is, the hand gesture is a gesture of griping or holding the user terminal with the two hands. The second preset value is negative, the first preset value is positive, and the preset range has an upper limit less than the first preset value and a lower limit greater than the second preset value.

Optionally, multiple pressure sensors may be arranged on the back face of the user terminal. The user terminal determines an outline of the hand according to positions of the pressure sensors which have sensed pressure. The user terminal determines whether the hand griping the user terminal is the left hand, the right hand or the two hands according to the outline of the hand. For the left hand and the right hand, it is also necessary to determine whether the outline of the hand includes an outline of five fingers. If the outline of the hand includes the outline of the five fingers, the hand gesture is a gesture of holding the user terminal with two hands. If the outline of the hand does not include the outline of the five fingers and the right hand grips the user terminal, the hand gesture is a gesture of griping and touching the user terminal with the right hand. If the outline of the hand does not include the outline of five fingers and the left hand grips the user terminal, the hand gesture is a gesture of griping and touching the user terminal with the left hand.

The gesture of holding the user terminal with the two hands is a gesture of griping the user terminal with one hand and touching the user terminal with the other hand.

In S105, if the hand gesture is a gesture of griping the user terminal with two hands or a gesture of holding the user terminal with two hands, the preset touch control area is configured to an entire area of the display interface.

If the hand gesture is the gesture of griping the user terminal with two hands, all fingers of two hands may touch the entire screen, so that the preset touch control area may be configured and the preset eye control area is not configured.

In S106, if the hand gesture is a gesture of griping and touching the user terminal with a right hand, the preset touch control area is configured to a right touch control area and the preset eye control area is configured to an area of the display interface other than the right touch control area.

The right touch control area is a maximal touchable area for a thumb of the right hand when the user grips the user terminal with the right hand. The right touch control area may be an area preset by the user terminal or an area manually configured by the user. Similarly, the right touch control area may be updated according to a position where a touch action of the user falls on the display interface.

In S107, if the hand gesture is a gesture of griping and touching the user terminal with a left hand, the preset touch control area is configured to a left touch control area and the preset eye control area is configured to an area of the display interface other than the left touch control area.

The left touch control area is a maximal touchable area for a thumb of the left hand when the user grips the user terminal with the left hand. The left touch control area may be an area preset by the user terminal or an area manually configured by the user. Similarly, the left touch control area may be updated according to a position where a touch action of the user falls on the display interface.

Each of the left touch control area and right touch control area described above may be a sector-shaped area drawn by the thumb of the hand of the user which grips the user terminal.

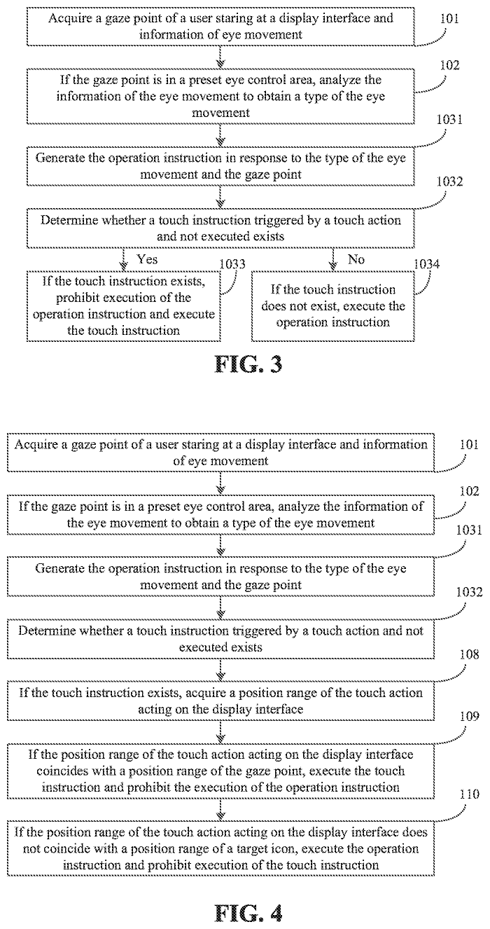

On the basis of the above technical solution, as shown in FIG. 3, the step S103 in which the operation instruction is executed according to the type of the eye movement and the gaze point, may include steps described below.

In S1031, the operation instruction is generated in response to the type of the eye movement and the gaze point.

The user terminal stores a list of instructions. Each of the instructions is triggered by the type of a corresponding action and a position at which the action acts. The embodiment may search for an operation instruction corresponding to the type of the eye movement and a position of the gaze point at which the eye movement acts.

In S1032, it is determined whether a touch instruction triggered by a touch action and not executed exists.

The touch instruction is triggered by the touch action. The touch action includes for example click, double-click, long press on a point of the display screen. If multiple instructions exists, trigger conditions of the multiple instructions are acquired. If one of the multiple instructions is triggered by touch, the instruction is the touch instruction. The determination of existence of the touch instruction triggered by the touch action and not executed enables to determine whether the touch instruction exists in a preset time period of generating the operation instruction.

In S1033, if the touch instruction exists, execution of the operation instruction is prohibited and the touch instruction is executed.

In S1034, if the touch instruction does not exist, the operation instruction is executed.

In the embodiment, execution priority of the touch instruction triggered by the touch action is higher than execution priority of the operation instruction triggered by an eye control action.

On the basis of the above technical solution, as shown in FIG. 4, after the S1032, the method further includes steps described below.

In S108, if the touch instruction exists, a position range of the touch action acting on the display interface is acquired; if the touch instruction does not exist, the operation instruction is executed.

In S109, if the position range of the touch action acting on the display interface coincides with a position range of the gaze point, the touch instruction is executed and the execution of the operation instruction is prohibited.

If an overlapping ratio of the position range of the touch action to the position range of the gaze point is greater than or equal to a preset ratio, it is considered that the position range of the touch action coincides with the position range of the gaze point.

In S110, if the position range of the touch action does not coincide with a position range of a target icon, the operation instruction is executed and execution of the touch instruction is prohibited.

If an overlapping ratio of the position range of the touch action to the position range of the gaze point is less than the preset ratio, it is considered that the position range of the touch action does not coincide with the position range of the gaze point.

If the position range of the touch action acting on the display interface does not coincide with the position range of the target icon, corresponding instructions to be executed may be different in different scenarios. Optionally, in a game scenario or a typing scenario, the position range of the gaze point of the user usually does not coincide with the position range of the touch action of the user, the execution of the operation instruction is prohibited and the touch instruction may be executed. Optionally, in a reading scenario, the gaze point of the user does not coincide with the touch action of the user, the execution of the touch instruction is prohibited and the operation instruction may be executed.

On the basis of the above technical solution, the step S1031 in which the operation instruction is generated in response to the type of the eye movement and the gaze point may include steps described below.

It is determined whether the type of the eye movement is a preset type; if the type of the eye movement is the preset type, the operation instruction is acquired based on a position of the gaze point according to a preset correspondence table of positions of the gaze point and instructions.

Only several specific preset types of actions are used as a condition for acquiring the operation instruction.

The user terminal stores the preset correspondence table. Each instruction of the plurality of instructions is triggered by the type of corresponding action and a position of the action acting on. The embodiment 1 may search for the operation instruction corresponding to a position of the gaze point that the eye movement with the preset type acts on from the preset corresponding table.

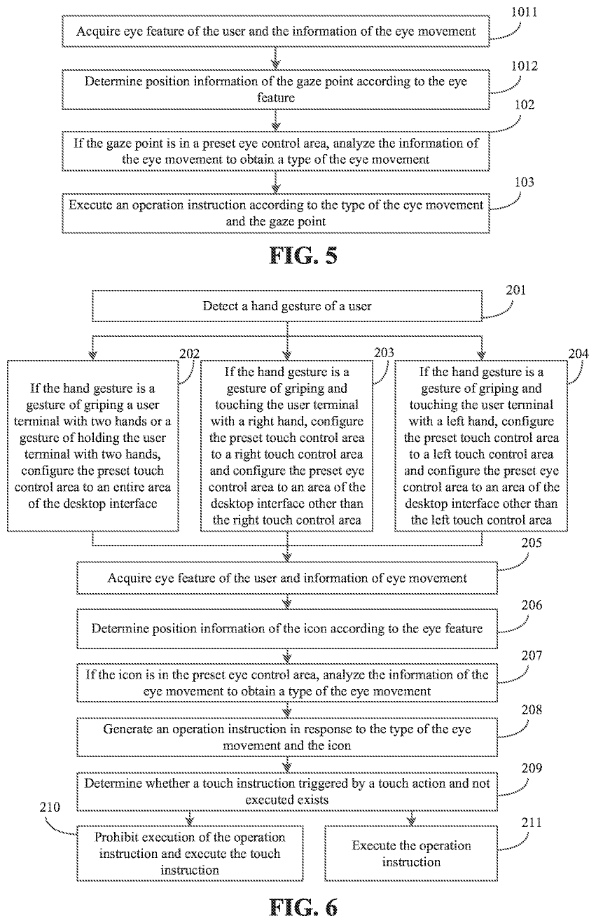

On the basis of the above technical solution, as shown in FIG. 5, the step S101 in which the gaze point of the user staring at the display interface and the information of the eye movement are acquired may include steps described below.

In 51011, eye feature of the user and the information of the eye movement are acquired.

The eye feature includes a pupillary distance, a pupil size, a change of the pupil size, pupil brightness contrast, a corneal radius, iris information and other features for representing subtle changes of the eyes. The eye feature may be extracted by image capturing or scanning just like the way of acquiring the information of the eye movement.

In S1012, position information of the gaze point is determined according to the eye feature.

The step S1021 may be implemented through eye-tracking technology. Eye-tracking is a technology that mainly studies acquisition, modeling and simulation of the information of the eye movement, and estimates a direction of the line-of-sight and the position of the gaze point. When eyes of people look in different directions, there are subtle changes in the eyes. These changes will generate features that may be extracted. The user terminal may extract these features by the image capturing or scanning, so as to track changes of the eyes in real time, predict and respond to a state and requirement of the user, achieving a purpose of controlling the user terminal with the eyes.

Preferably, the embodiment may also configure a desktop area commonly used by the user to the preset eye control area.

### Embodiment 2

FIG. 6 is a flowchart of an operation instruction execution method in the embodiment 2 of the present disclosure. The embodiment may be applied to control of a user terminal. The method may be performed by an operation instruction execution apparatus and the apparatus is applied to the user terminal. It is supposed that a display interface in the embodiment is a desktop interface and a gaze point is an application icon. The method includes steps described below.

In S201, a hand gesture of a user is detected.

In S202, if the hand gesture is a gesture of griping a user terminal with two hands or a gesture of holding the user terminal with two hands, the preset touch control area is configured to an entire area of the desktop interface.

In S203, if the hand gesture is a gesture of griping and touching the user terminal with a right hand, the preset touch control area is configured to a right touch control area and the preset eye control area is configured to an area of the desktop interface other than the right touch control area.

In S204, if the hand gesture is a gesture of griping and touching the user terminal with a left hand, the preset touch control area is configured to a left touch control area and the preset eye control area is configured to an area of the desktop interface other than the left touch control area.

In S205, eye feature of the user and information of eye movement are acquired.

In S206, position information of the icon is determined according to the eye feature.

In S207, if the icon is in the preset eye control area, the information of the eye movement is analyzed to obtain a type of the eye movement.

In S208, an operation instruction is generated in response to the type of the eye movement and the icon.

In S209, it is determined whether a touch instruction triggered by a touch action and not executed exists; if yes, S210 is executed; if not, S211 is executed.

In S210, execution of the operation instruction is prohibited and the touch instruction is executed.

In S211, the operation instruction is executed.

The embodiment enhances user maneuverability and flexibility for a scenario of griping a cellphone with one hand. A problem that one hand cannot control an entire screen of the cellphone is solved.

### Embodiment 3

The embodiment of the present disclosure provides an operation instruction execution apparatus, which may execute the operation instruction execution method provided by any embodiment of the present disclosure, and have functional modules and beneficial effects corresponding to the operation instruction execution method.

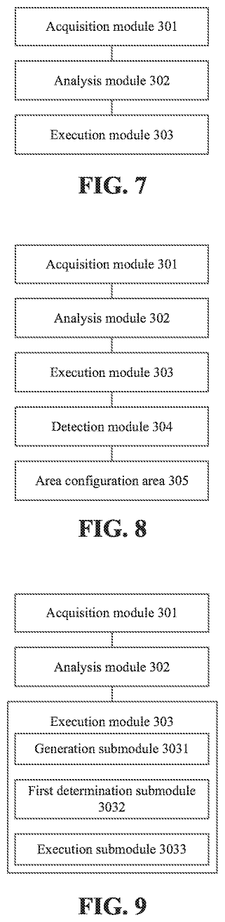

FIG. 7 is a structural diagram of an operation instruction execution apparatus in the embodiment 3 of the present disclosure. As shown in FIG. 7, the apparatus may include an acquisition module 301, an analysis module 302 and an execution module 303.

The acquisition module 301 is configured to acquire a gaze point of a user staring at a display interface and information of eye movement.

The analysis module 302 is configured to, if the gaze point is in the preset eye control area, analyze the information of the eye movement to obtain the type of the eye movement.

The execution module 303 is configured to execute an operation instruction according to the type of the eye movement and the gaze point.

The embodiment provides eye control for the user terminal in the preset eye control area and provides touch control for the user terminal in an area other than the preset eye control area, so that the user may operate at any position of the display interface. In this way, an effect of controlling on an entire screen is achieved, convenient control of a display screen is achieved, misoperations are reduced and user experience is improved.

Optionally, the display interface includes the preset eye control area and a preset touch control area. The preset eye control area has an eye control function or a touch control function, and the preset touch control area has the touch control function.

Optionally, as shown in FIG. 8, the apparatus further includes a detection module 304 and an area configuration module 305.

The detection module 304 is configured to detect a hand gesture of the user.

The area configuration 305 is configured to, if the hand gesture is a gesture of griping a user terminal with two hands or a gesture of holding the user terminal with two hands, configure the preset touch control area to an entire area of the display interface; if the hand gesture is a gesture of griping and touching the user terminal with a right hand, configure the preset touch control area to a right touch control area and configure the preset eye control area to an area of the display interface other than the right touch control area, where the right touch control area is a maximal touchable area for a thumb of the right hand when the user grips the user terminal with the right hand; and if the hand gesture is a gesture of griping and touching the user terminal with a left hand, configure the preset touch control area to a left touch control area and configure the preset eye control area to an area of the display interface other than the left touch control area, where the left touch control area is a maximal touchable area for a thumb of the left hand when the user grips the user terminal with the left hand.

Optionally, as shown in FIG. 9, the execution module 303 includes a generation submodule 3031, a first determination submodule 3032 and an execution submodule 3033.

The generation submodule 3031 is configured to generate the operation instruction in response to the type of the eye movement and the gaze point.

The first determination submodule 3032 is configured to determine whether a touch instruction triggered by a touch action and not executed exists.

The execution submodule 3033 is configured to, if the touch instruction exists, prohibit execution of the operation instruction and execute the touch instruction; if the touch instruction does not exist, execute the operation instruction.

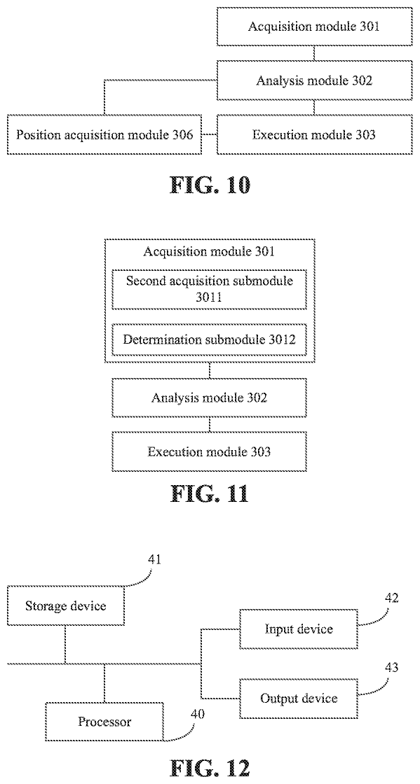

Optionally, as shown in FIG. 10, the apparatus further includes a position acquisition module 306.

The position acquisition module 306 is configured to, if the touch instruction exists, acquire a position range of the touch action acting on the display interface.

The execution module 303 is configured to, if the position range of the touch action acting on the display interface does not coincide with a position range of a target icon, execute the operation instruction and prohibit execution of the touch instruction; if the position range of the touch action acting on the display interface does not coincide with a position range of a target icon, execute the operation instruction and prohibit execution of the touch instruction.

Optionally, the generation submodule 3031 is configured to determine whether the type of the eye movement is a preset type; if the type of the eye movement is the preset type, acquire the operation instruction according to a preset correspondence table of positions of the gaze point and instructions.

Optionally, as shown in FIG. 11, the acquisition module 301 may include a second acquisition submodule 3011 and a determination submodule 3012.

The second acquisition submodule 3011 is configured to acquire eye feature of the user and the information of the eye movement.

The determination submodule 3012 is configured to determine position information of the gaze point according to the eye feature.

### Embodiment 4

FIG. 12 is a structural diagram of a user terminal in the embodiment 4 of the present disclosure. As shown in FIG. 12, the user terminal includes a processor 40, a storage device 41, an input device 42 and an output device 43. The user terminal may include at least one processor 40. One processor 40 is taken as an example in FIG. 12. The processor 40, the storage device 41, the input device 42 and the output device 43 in the user terminal may be connected to each other through a bus or other means. The bus is taken as an example in FIG. 12.

The storage device 41, as a computer readable storage medium, may be configured to store software programs, computer executable programs and modules, such as program instructions or modules (for example, the acquisition module 301, the analysis module 302 and the execution module 303 in the operation instruction execution apparatus) corresponding to the operation instruction execution method in the embodiment 4 of the present disclosure. The processor 40 executes various functional applications and data processing of the user terminal through operating the software programs, instructions and modules. In other words, the above operation instruction execution method is implemented.

The storage device 41 may include a program storage area and a data storage area. The program storage area may store an operating system and an application required for implementing at least one function. The data storage area may store data created according to the usage of the terminal and so on. In addition, the storage device 41 may include at least one of a high-speed random-access memory or a non-volatile memory, such as at least one magnetic disk storage, flash memory, or other non-volatile solid-state storage. In some instances, the storage device 41 may further include a memory arranged remotely relative to the processor 40. The remote memory may be connected to the user terminal through a network. Examples of the above network include, but not limited to, the Internet, an intranet, a local area network (LAN), a mobile communication network and combinations thereof.

The input device 42 may acquire the gaze point of a user staring at a display interface and information of eye movement, and may generate key signal input related to user settings and function control of the user terminal. The output device 43 may include a playing device such as a loudspeaker.

### Embodiment 5

The embodiment 5 of the present disclosure further provides a storage medium including computer executable instructions. The computer executable instructions, when executed by a processor in a computer, are used for executing an operation instruction execution method. The method includes steps described below.

A gaze point of a user staring at a display interface and information of eye movement are acquired.

If the gaze point is in a preset eye control area, the information of the eye movement is analyzed to obtain a type of the eye movement.

An operation instruction is executed according to the type of the eye movement and the gaze point.

Of course, the computer executable instructions, which are included in the storage medium provided by the embodiment 5 of the present disclosure, are not limited to execute the operations in the above method, but also may execute the related operations in the operation instruction execution method provided by any embodiment of the present disclosure.

Through the above description about implementations, those skilled in the art may clearly understand that the present disclosure may be implemented by software and necessary general hardware, or by hardware, but in many cases the former is a better implementation. Based on this understanding, the technical solution of the present disclosure may be embodied in a form of a software product essentially, or a contribution part to prior art of the technical solution of the present disclosure may be embodied in a form of a software product. The computer software product may be stored in a computer readable storage medium, such as a floppy disk of the computer, a Read-Only Memory (ROM), a Random Access Memory (RAM), a flash disk, a hard disk or a compact disc, and includes several instructions to enable a computer equipment (which may be a personal computer, a server or a network device, etc.) to execute the method of each embodiment of the present disclosure.

It should be noted that, in the embodiment of the operation instruction execution apparatus, various units and modules included in the search apparatus are only divided according to a functional logic, but are not limited to the above division, as long as the corresponding functions may be implemented. In addition, the specific names of respective functional units are only used for the convenience of distinguishing from each other, and are not used for limiting the scope of protection of the present disclosure.

It should be noted that the above are only preferred embodiments of the present disclosure and technical principles applied in the present disclosure. Those skilled in the art will understand that the present disclosure is not limited to the specific embodiments described herein. For those skilled in the art, various obvious changes, readjustments and substitutions may be conducted without departing from the protection scope of the present disclosure. Therefore, although the present disclosure is described in detail through the above embodiments, without departing from the conception of the present disclosure, the present disclosure may include more equivalent embodiments. The scope of the present disclosure is determined by the scope of accompanying claims.

What is claimed is:

1. An operation instruction execution method, comprising:
acquiring a gaze point of a user staring at a display interface and information of eye movement;
in response to determining that the gaze point is in a preset eye control area, analyzing the information of the eye movement to obtain a type of the eye movement; and
executing an operation instruction according to the type of the eye movement and the gaze point.

2. The method of claim 1, wherein the display interface comprises the preset eye control area and a preset touch control area, the preset eye control area has an eye control function or a touch control function, and the preset touch control area has the touch control function.

3. The method of claim 2, the method further comprises:
detecting a hand gesture of the user; and
in response to determining that the hand gesture is a gesture of griping a user terminal with two hands or a gesture of holding the user terminal with two hands, configuring the preset touch control area to an entire area of the display interface;
in response to determining that the hand gesture is a gesture of griping and touching the user terminal with a right hand, configuring the preset touch control area to a right touch control area and configuring the preset eye control area to an area of the display interface other than the right touch control area, wherein the right touch control area is a maximal touchable area for a thumb of the right hand in a case where the user grips the user terminal with the right hand; or
in response to determining that the hand gesture is a gesture of griping and touching the user terminal with a left hand, configuring the preset touch control area to a left touch control area and configuring the preset eye control area to an area of the display interface other than the left touch control area, wherein the left touch control area is a maximal touchable area for a thumb of the left hand in a case where the user grips the user terminal with the left hand.

4. The method of claim 1, wherein executing the operation instruction according to the type of the eye movement and the gaze point comprises:
generating the operation instruction in response to the type of the eye movement and the gaze point;
determining whether a touch instruction triggered by a touch action and not executed exists; and
in response to determining that the touch instruction exists, prohibiting execution of the operation instruction and executing the touch instruction; or
in response to determining that the touch instruction does not exist, executing the operation instruction.

5. The method of claim 4, wherein after determining whether the touch instruction triggered by the touch action and not executed exists, the method further comprises:
in response to determining that the touch instruction exists, acquiring a position range of the touch action acting on the display interface; and
in response to determining that the position range of the touch action acting on the display interface coincides with a position range of the gaze point, executing the touch instruction and prohibiting the execution of the operation instruction; or
in response to determining that the position range of the touch action acting on the display interface does not coincide with a position range of a target icon, executing the operation instruction and prohibiting execution of the touch instruction.

6. The method of claim 4, wherein generating the operation instruction in response to the type of the eye movement and the gaze point comprises:
determining whether the type of the eye movement is a preset type; and
in response to determining that the type of the eye movement is the preset type, acquiring the operation instruction based on a position of the gaze point according to a correspondence table of a plurality of positions of the gaze point and a plurality of instructions.

7. The method of claim 1, wherein acquiring the gaze point of the user staring at the display interface and the information of the eye movement comprises:
acquiring eye feature of the user and the information of the eye movement; and
determining position information of the gaze point according to the eye feature.

8. The method of claim 2, wherein acquiring the gaze point of the user staring at the display interface and the information of the eye movement comprises:
acquiring eye feature of the user and the information of the eye movement; and
determining position information of the gaze point according to the eye feature.

9. The method of claim 3, wherein acquiring the gaze point of the user staring at the display interface and the information of the eye movement comprises:
acquiring eye feature of the user and the information of the eye movement; and
determining position information of the gaze point according to the eye feature.

10. The method of claim 4, wherein acquiring the gaze point of the user staring at the display interface and the information of the eye movement comprises:
acquiring eye feature of the user and the information of the eye movement; and
determining position information of the gaze point according to the eye feature.

11. The method of claim 5, wherein acquiring the gaze point of the user staring at the display interface and the information of the eye movement comprises:
acquiring eye feature of the user and the information of the eye movement; and
determining position information of the gaze point according to the eye feature.

12. The method of claim 6, wherein acquiring the gaze point of the user staring at the display interface and the information of the eye movement comprises:
acquiring eye feature of the user and the information of the eye movement; and
determining position information of the gaze point according to the eye feature.

13. An operation instruction execution apparatus, comprising:
a processor; and
a storage device for storing instructions executable by the processor,
wherein the processor is configured to:
acquire a gaze point of a user staring at a display interface and information of eye movement;
in response to determining that the gaze point is in a preset eye control area, analyze the information of the eye movement to obtain a type of the eye movement; and
execute an operation instruction according to the type of the eye movement and the gaze point.

14. A user terminal, comprising:
at least one processor; and
a storage device, which is configured to store at least one program, wherein the at least one program, when executed by the at least one processor, causes the at least one processor to implement an operation instruction execution method,
wherein the operation instruction execution method comprises:
acquiring a gaze point of a user staring at a display interface and information of eye movement;
in response to determining that the gaze point is in a preset eye control area, analyzing the information of the eye movement to obtain a type of the eye movement; and
executing an operation instruction according to the type of the eye movement and the gaze point.

15. A computer readable storage medium, wherein computer programs are stored in the computer readable storage medium, the computer programs, when executed by a processor, implement the operation instruction execution method of claim 1.
